(19) United States
(12) Patent Application Publication
(10) Pub. No.: US 2013/0061176 A1
(43) Pub. Date: Mar. 7, 2013

(54) ITEM SELECTION DEVICE, ITEM SELECTION METHOD AND NON-TRANSITORY INFORMATION RECORDING MEDIUM

(71) Applicant: Masashi TAKEHIRO, Minato-ku (JP)

(72) Inventor: Masashi TAKEHIRO, Minato-ku (JP)

(73) Assignee: Konami Digital Entertainment Co., Ltd., Tokyo (JP)

(21) Appl. No.: 13/602,782

(22) Filed: Sep. 4, 2012

(30) Foreign Application Priority Data
Sep. 7, 2011 (JP) 2011-195287

(51) Int. Cl. G06F 3/048

(52) U.S. Cl. 715/823

(57) ABSTRACT

In an item selection device, a display controller displays an item on a screen. A first acquirer acquires a position of contact by a user on the front side of the screen. A second acquirer acquires a position of contact by a user on the back side of the screen. A measurer measures an inclination of the item selection device. An outputter outputs an item selected based on the position acquired by the first acquirer when the measured inclination satisfies a first condition and outputs an item selected based on the position acquired by the second acquirer when the measured inclination satisfies a second condition. Furthermore, the display controller displays the item in a first state when the measured inclination satisfies the first condition and displays the item in a second state when the measured inclination satisfies the second condition.

### CROSS-REFERENCE TO RELATED APPLICATION

This application claims the benefit of Japanese Patent Application No. 2011-195287, filed on Sep. 7, 2011, the entire disclosure of which is incorporated by reference herein.

### TECHNICAL FIELD

This application relates generally to an item selection device, an item selection method and a non-transitory information recording medium suitable for making a selection of an item displayed on a screen easy in accordance with the inclination of the device.

### BACKGROUND ART

In recent years, there has been a proliferation of electronic devices equipped with so-called touch panel input devices that detect contact from a user on a screen and/or the like and are thus manipulated for input. A growing number of portable electronic devices such as mobile phones, portable game systems and/or the like receive operational input by a touch panel input device. Accompanying this, development to improve the operability of touch panels is proceeding in various quarters.

For example, in Unexamined Japanese Patent Application Kokai Publication No. 2009-048245, technology is disclosed that can appropriately prevent input errors in an input-receiving device provided with a touch panel, even when a continuous touch operation from the user is performed.

An input device for detecting contact with a screen together with that screen is sometimes called a touch screen. In addition, an input device itself for detecting contact is sometimes called a touch pad.

### SUMMARY

The portable electronic devices noted above typically require input operations while the entire device is held by a user's hand, so there are times when operation becomes difficult due to the user's posture gripping the device. For example, when the user operates the device in a posture looking up at the screen with the device facing downward because the user is lying down looking upward, the user must operate the touch panel with the same fingers that are supporting the device. Consequently, problems readily occur, including operation of the touch panel becoming difficult, fatigue from operation readily occurring and accidental dropping of the device causing damage or injury.

In consideration of the foregoing, it is an objective of the present invention to provide an item selection device, an item selection method and a non-transitory information recording medium suitable for making a selection of an item displayed on a screen easy in accordance with the inclination of the device.

In order to achieve the above objective, the item selection device according to a first aspect of the present invention is an item selection device for allowing a user to select an item, comprising a display controller, a first acquirer, a second acquirer, a measurer and an outputter.

The display controller displays the item on a screen.

An “item” shows a so-called button (selection button) for receiving operation input from a user. The display controller displays on a screen (monitor) provided in this item selection device various image data along with items for receiving operation input from the user as image data mimicking selection buttons such as icons and/or the like. The user can accomplish desired operation input by selecting an item displayed on the screen.

For example, in a setting for accomplishing selection of either “yes” or “no”, the display controller displays on the screen an item image corresponding to “yes” and an item image corresponding to “no”. Furthermore, when the item image corresponding to “yes” is selected, a process corresponding to “yes” is executed, and when the item image corresponding to “no” is selected, a process corresponding to “no” is executed.

The first acquirer acquires a position of contact by the user on a front side of the screen.

That is to say, the first acquirer acquires the position of a contact (touch) by the user detected by a so-called touch panel input device and/or the like. This kind of device that can detect a contact may be provided in the item selection device itself or may be provided on an external device. “Front side of the screen” means the same side as the face on which the screen is positioned in the item selection device. For example, the first acquirer acquires the position of contact detected using a so-called touch screen input device overlaid on the screen and integrated with the screen. The “front side of the screen” does not necessarily have to be the same face as the screen, but may be within a range such that the user can simultaneously see the condition of contact to this input device and the screen. For example, the first acquirer may acquire the position of contact detected by a so-called touch pad input device positioned at the side of the screen.

The second acquirer acquires a position of contact by the user on a back side of the screen.

That is to say, the item selection device further comprises a second acquirer in addition to the above-described first acquirer to acquire the position of contact by the user. The “back side of the screen” is the general idea of the “front side of the screen” in the above-described first acquirer, and means the side opposite the side on which the screen is positioned in the item selection device. That is to say, the second acquirer acquires the position of contact (touch) by the user from the side opposite the screen and executes an input process based on that contact position. For example, the second acquirer acquires the position of contact detected by an input device positioned on the back of the screen.

The measurer measures an inclination of the item selection device.

The “inclination of the item selection device” indicates in what direction the item selection device as a whole is facing with respect to the direction of gravity, and typically is evaluated through the angle formed by an outward-facing normal vector to the screen and the gravity vector. The measurer detects the gravity direction using an acceleration sensor and/or the like and measures the extent to which the item selection device is inclined with respect to the direction of gravity.

The outputter:
(a1) outputs an item selected based on the position of contact acquired by the first acquirer when the measured inclination satisfies a prescribed first condition, and
(a2) outputs an item selected based on the position of contact acquired by the second acquirer when the measured inclination satisfies a prescribed second condition.

That is to say, the outputter selects the acquirer to be the standard for outputting items from between the two acquirers based on the inclination of the item selection device as a whole measured by the measurer. The outputter outputs the item displayed at the position on the screen corresponding to the contact position based on the contact position acquired from one of the two acquirers.

The first acquirer and the second acquirer correspond to the front side and the back side, respectively, of the screen, so for example the outputter selects the first acquirer when the item selection device is facing so that the front side of the screen is easy to contact and operate, and conversely selects the second acquirer when the item selection device is facing so that the back side of the screen is easy to contact and operate. Through this, the user can select an item displayed on the screen by accomplishing contact operations from the side that is easier to operate, out of the front side and back side of the item selection device, in accordance with the inclination of the item selection device.

Furthermore, the display controller:

(b1) displays the item in a prescribed first state when the measured inclination satisfies the prescribed first condition, and

(b2) displays the item in a prescribed second state when the measured inclination satisfies the prescribed second condition.

That is to say, the display controller, similar to the outputter, causes the process of displaying the item to change based on the inclination of the item selection device as a whole measured by the measurer. Specifically, out of two states prepared as states for displaying an item, the display controller displays the item in a prescribed first state when the inclination satisfies the prescribed first condition and displays the item in a prescribed second state when the inclination satisfies the prescribed second condition.

The case where the inclination satisfies the prescribed first condition is the case where the outputter outputs an item selected based on the contact position acquired on the front side of the screen, so the display controller displays the item so as to mimic a push button that sticks out toward the front side of the screen, for example, to encourage the user to contact and operate the device from the front side of the screen. Conversely, the case where the inclination satisfies the prescribed second condition is the case where the outputter outputs an item selected based on the contact position acquired on the back side of the screen, so the display controller displays the item so as to mimic a push button that sticks out toward the back side of the screen, for example, to encourage the user to contact and operate the device from the back side of the screen.

Through this kind of composition, the item selection device of the present invention is provided with two acquirers corresponding respectively to the front side and the back side of the screen, and by changing the acquirer acquiring the position of a contact operation from the user in accordance with the inclination of the item selection device, the screen for receiving the operation input is changed. By changing the display state of the items in accordance with the inclination of the item selection device, it is easy for the user to confirm from which of the surfaces, either the front side or the back side, input should be made at present. As a result, even when the item selection device of the present invention is inclined in various ways through postures with which such is held by the user, it is easy for the user to select items displayed on the screen because input is received from the surface the user can operate most easily, out of the front side and the back side.

In the item selection device of the present invention:
the prescribed first condition may be satisfied when an angle formed by an outward facing normal vector to the screen and a gravity vector is an obtuse angle; and
the prescribed second condition may be satisfied when an angle formed by an outward facing normal vector to the screen and a gravity vector is an acute angle.

The “outward facing normal vector to the screen” is a vector starting at a point on the screen and orthogonal to that screen, and is a vector facing the outside of the item selection device. The “gravity vector” is a vector in the direction of gravity, that is to say facing straight downward toward the earth's surface. The gravity vector is acquired by using a function of an acceleration sensor and/or the like. The measurer acquires the outside-facing normal vector to the screen and the gravity vector and measures the angle formed by these (normally a value at least 0 degrees and not greater than 180 degrees). Furthermore, the outputter changes which item based on an acquirer out of the two acquirers

For example, “the case when an angle formed by an outward-facing normal vector to the screen and a gravity vector is an obtuse angle” is the case when the screen is facing upward, that is to say toward the sky, and in general corresponds to the case when the user is operating the item selection device while looking down at the screen. At this time, the outputter outputs items selected based on the contact position obtained from the front side of the screen.

In contrast, “the case when an angle formed by an outward-facing normal vector to the screen and a gravity vector is an acute angle” is the case when the screen is facing downward, that is to say is facing toward the earth's surface, and for example corresponds to the case when the user is operating the item selection device while looking up at the screen. At this time, the outputter outputs items selected based on the contact position acquired from the back side of the screen.

That is to say, the outputter outputs items selected based on the contact position acquired from the side facing upward out of the front side and the back side of the screen, even when the item selection device is inclined such that the screen faces either up or down. Consequently, the user operating the item selection device while holding such in a hand does not need to operate the device using fingers on the underside of the device, that is to say fingers supporting the device, so operation becomes easier for the user, fatigue from operation is reduced and damage caused by dropping the device can be prevented.

In the item selection device of the present invention:
the prescribed first state may be a state showing that a three-dimensional shape of the item is a protrusion;
the prescribed second state may be a state showing that a three-dimensional shape of the item is an indentation; and
the display controller:
(c1) may display the item changed from the prescribed first state to a state showing that the three-dimensional shape of the item is not a protrusion when the measured inclination satisfies the prescribed first condition, and moreover a position of contact by the user is acquired by the first acquirer and the item is selected based on the position of contact, and
(c2) may display the item changed from the prescribed second state to a state showing that the three-dimensional shape of the item is not an indentation when the measured inclination satisfies the prescribed second condition, and moreover a position of contact by the user is acquired by the second acquirer and the item is selected based on the position of contact.

Here, the “state showing that a three-dimensional shape of the item is a protrusion” is the state of an item mimicking a three-dimensional shape as though sticking out toward the user viewing the screen, and for example is a state showing a button that can be selected by being pressed from above. Furthermore, the “state showing that a three-dimensional shape of the item is not a protrusion” is any state other than this “state showing that a three-dimensional shape of the item is a protrusion”, and for example could be a flat state that is not a three-dimensional state or could be a state that is a three-dimensional shape but does not stick out toward the user viewing the screen.

That is to say, when the measured inclination satisfies the prescribed first condition, that is to say when items are selected from the front side of the screen, items are displayed in a state mimicking a three-dimensional shape as though sticking out toward the user viewing the screen. Furthermore, when an item is selected from the front side of the screen, the display controller changes the state of that selected item to a state differing from before selection. Through this, the user can select an item with a sensation as though pressing a button from above the screen.

In contrast, the “state showing that a three-dimensional shape of the item is an indentation” is the state of an item mimicking a three-dimensional shape as though sunken from the user viewing the screen, and for example is a state showing from the back side a button that can be selected by being pressed from above. Furthermore, the “state showing that a three-dimensional shape of the item is not an indentation” is any state other than this “state showing that a three-dimensional shape of the item is an indentation”, and for example could be a flat state that is not a three-dimensional state or could be a state that is a three-dimensional shape but is not sunken from the user viewing the screen.

That is to say, when the measured inclination satisfies the prescribed second condition, that is to say when items are selected from the back side of the screen, items are displayed in a state mimicking a three-dimensional shape as though sunken from the user viewing the screen. Furthermore, when an item is selected from the back side of the screen, the display controller changes the state of that selected item to a state differing from before selection. Through this, the user can select an item with a sensation as though pressing a button from the back of the screen.

Through this kind of composition, with the item selection device of the present invention the display controller displays the state showing that the three-dimensional shapes of the items are protrusions when items are selected from the front side of the screen in accordance with the inclination measured by the measurer and displays the state showing that the three-dimensional shapes of the items are indentations when items are selected from the back side of the screen. As a result, a user operating the item selection device can readily recognize from which out of the front and back surfaces of the screen the item should be selected, improving operability of an item selection device with which selection is possible from both the front and back of the screen.

In the item selection device of the present invention:
the state showing that the three-dimensional shape of the item is not a protrusion may be the prescribed second state; and
the state showing that the three-dimensional shape of the item is not an indentation may be the prescribed first state.

That is to say, similar to the above-described item selection device, the display controller displays the state showing that the three-dimensional shapes of items are protrusions or indentations in accordance with the inclination measured by the measurer. On the other hand, when an item is selected, the display controller changes from the state showing that the three-dimensional shape of that item is a protrusion to the state showing that the shape is an indentation, or changes from the state showing this to be an indentation to the state showing this to be a protrusion. That is to say, when an item is selected, the state displaying the item changes from one to the other out of the two states, namely “the state showing that the three-dimensional shape of the item is a protrusion” and “the state showing that the three-dimensional shape of the item is an indentation.”

With this kind of composition, by preparing at least the two states, namely “the state showing that the three-dimensional shape of the item is a protrusion” and “the state showing that the three-dimensional shape of the item is an indentation,” as states displaying the items, the item selection device of the present invention is such that it is possible to show that an item is selected as though the user has pressed a button from the surface where the contact operation was. Consequently, the item selection device of the present invention can efficiently realize making the fact that an item was selected easy for the user to recognize, while reducing data usage volume to the extent possible.

In the item selection device of the present invention, at least one out of a degree indicating the protrusion of the state indicating that the three-dimensional shape of the item is a protrusion, and a degree indicating the indentation of the state indicating that the three-dimensional shape of the item is an indentation (hereafter called “display state degrees”) may be determined based on a position of the item displayed on the screen.

The “degree indicating that the state indicating that the three-dimensional shape of the item is a protrusion is the protrusion (protrusion degree)” is the size of the extent to which the three-dimensional shape sticks out in a state of an item displayed so as to mimic a three-dimensional shape as though sticking out toward the user viewing the screen. The “degree indicating that the state indicating that the three-dimensional shape of the item is an indentation is the indentation (indentation degree)” is the size of the extent of sunkenness of the three-dimensional shape in a state of an item displayed so as to mimic a three-dimensional shape as though sunken from the user viewing the screen. Below, the “protrusion degree” and the “indentation degree” are together called “display state degrees.”

That is to say, the items displayed on the screen are not limited to being displayed in a uniform state regardless of the position on the screen, for various display state degrees can be set based on the position where displayed. For example, the display state degrees of items may be made relatively small at positions on the screen where it is difficult for the user's finger to reach and selecting an item is difficult, and conversely the display state degrees may be made relatively large at positions on the screen where it is easy for the user's finger to reach and selecting an item is easy. In this manner, the display controller displays items by applying a strength to the display state degree depending on the position on the screen.

By setting the protrusion degree and the indentation degree (display state degrees) for the items based on the positions on the screen where those items are displayed, the item selection device of the present invention can make it easy for the user to confirm from outward appearance whether pressing relatively strongly is good or whether there is no need for very strong pressing in order to make a selection, depending on the item. Through this, it is possible to control to the extent possible behavior such as pressing with an unnecessarily strong force items displayed at positions where selection is difficult, and it is possible to improve operability, and prevent damage or dropping of the device caused by operation of the device in an unreasonable posture.

In the item selection device of the present invention, as a distance of the position of the item displayed on the screen from a prescribed standard position on the screen increases, the display state degree of the item may increase.

That is to say, with the item selection device of the present invention, the display state degrees of the items displayed on the screen are determined based on the position where displayed, similar to the above description. However, to be more specific, these are set so that the display state degrees of these items increase as the distance to that item from a position that is a standard set in advance on the screen increases. That is to say, items on the screen are displayed so that the display state degrees thereof are smallest for those displayed at a prescribed standard position on the screen and gradually become larger as the distance of the position where displayed from this standard position increases.

For example, with an item selection device a user operates while holding with both hands from near both edges of the screen, near the center of the screen is difficult for the user's fingers to reach, so there are cases where selecting an item displayed near the center of the screen is difficult. In such a case, when the center of the screen and/or the like is set as a “prescribed standard position”, the items displayed at the center of the screen have smaller protrusion degrees or indentation degrees (display state degrees) compared to items displayed near the edges of the screen, that is to say the buttons are displayed not protruding very much or not sunken very much. Through this, the user viewing the screen can easily recognize that when selecting items displayed near the center of the screen, an item can be selected by pressing with relatively weak force compared to items displayed near the edges of the screen. The “prescribed standard position” is not limited to the center of the screen and can be set at various other positions where the display state degrees of the items should be relatively small.

In this manner, by setting the protrusion degree or the indentation degree (display state degrees) of the items so as to be larger as the distance from the prescribed standard position on the screen on which such is displayed increases, the item selection device of the present invention can make it easy for the user to confirm from an outward appearance that items in positions close to the standard position should be pressed relatively strongly and items in positions more distant from the standard position should be pressed relatively weakly. Through this, the item selection device of the present invention can control to the extent possible behavior such as pressing with unnecessarily strong force items that are displayed near the prescribed standard position on the screen, thereby improving operability and preventing damage or dropping of the device caused by operation of the device in an unreasonable posture.

In the item selection device of the present invention:
the first acquirer may further acquire a strength of contact by the user on the front side of the screen;
the second acquirer may further acquire a strength of contact by the user on the back side of the screen;
(d1) an item may be selected if the strength of contact acquired by the first acquirer is greater than a threshold value determined in accordance with the display state degree of the item displayed at a position based on the position of the contact; and
(d2) an item may be selected if the strength of contact acquired by the second acquirer is greater than a threshold value determined in accordance with the display state degree of the item displayed at a position based on the position of the contact.

That is to say, the first acquirer and the second acquirer, in addition to acquiring the absence or presence of a contact by the user and the position thereof, further acquire the strength of that contact. Here, “strength of contact” means the strength of the pressure when the user contacts the front side of the screen or the back side of the screen with a finger and/or the like, and for example is detected and acquired by a pressure-sensitive touch panel and/or the like. Furthermore, a threshold value for strength for determining when an item corresponding to that contact position has been selected is set in accordance with the display state degree of that item with respect to the strength of the acquired contact. Through this, an item is not selected immediately after detection of a contact, but rather an item is selected and output to the outputter only when pressed with a strength exceeding the threshold value.

For example, when the threshold value is set greater as the display state degree of an item increases, items mimicking a three-dimensional shape so as to be protruding more toward or be more sunken from the user viewing the screen cannot be selected without stronger pressing. That is to say, not only can the user confirm from outward appearance that an item cannot be selected without stronger pressing for items whose display state degrees are displayed larger, in reality selection is impossible without stronger pressing.

In this manner, the item selection device of the present invention, in addition to acquiring the absence or presence of contact by a user and the position thereof, further acquires the strength of that contact, and by setting a threshold value for the strength of contact that determines when an item is selected in accordance with the display state degree of that item, it is possible to make the strength of contact by a user's finger and/or the like necessary for selecting an item stronger or weaker depending on the item. Through this, it is possible to make it so that items displayed at positions that are difficult to select, for example, can be selected without pressing with unnecessarily strong force, thereby making it possible to further enhance effects such as improving operability.

In order to achieve the above objective, the item selection method according to a second aspect of the present invention is the item selection method executed by an item selection device for allowing a user to select an item and comprising a display controller, a first acquirer, a second acquirer, a measurer and an outputter, wherein the item selection method comprises a display step, a first acquisition step, a second acquisition step, a measurement step and an output step.

In the display step, the display controller displays the item on a screen.

In the first acquisition step, the first acquirer acquires a position of contact by the user on a front side of the screen.

In the second acquisition step, the second acquirer acquires a position of contact by the user on a back side of the screen.

In the measurement step, the measurer measures an inclination of the item selection device.

In the output step, the outputter:
(a1) outputs an item selected based on the position of contact acquired by the first acquirer when the measured inclination satisfies a prescribed first condition, and
(a2) outputs an item selected based on the position of contact acquired by the second acquirer when the measured inclination satisfies a prescribed second condition.

Furthermore, in the display step, the display controller:
(b1) displays the item in a prescribed first state when the measured inclination satisfies the prescribed first condition, and
(b2) displays the item in a prescribed second state when the measured inclination satisfies the prescribed second condition.

In order to achieve the above objective, the non-transitory information recording medium according to a third aspect of the present invention records a program for causing a computer to function as the above-described item selection device and causes the computer to execute the various steps of the above-described item selection method.

In addition, the above-described program can be recorded on a computer-readable non-transitory information recording medium such as a compact disc, a flexible disc, a hard disk, a magneto-optical disc, a digital video disc, magnetic tape, semiconductor memory and/or the like. This program is executed by being loaded into a temporary recording medium such as RAM (Random Access Memory) and/or the like.

The above-described program is independent of the computer that executes the program, and can be distributed and sold via a computer communications network composed of signal lines and/or the like that are transitory media for conveying the program. In addition, the above-described information recording medium can be distributed and sold independent of the computer.

With the present invention, it is possible to provide an item selection device, an item selection method and a non-transitory information recording medium suitable for making a selection of an item displayed on a screen easy in accordance with the inclination of the device.

### BRIEF DESCRIPTION OF THE DRAWINGS

A more complete understanding of this application can be obtained when the following detailed description is considered in conjunction with the following drawings, in which:

FIG. 1 is a drawing showing a functional composition of an item selection device according to a first embodiment of the present invention;

FIG. 2A is a drawing showing a summary composition of a typical information processing device with which the item selection device of the present invention is realized;

FIG. 2B is an external view of the typical information processing device with which the item selection device of the present invention is realized;

FIG. 3 is a drawing showing a functional composition of an item selection device according to a second embodiment of the present invention;

FIG. 4 is a drawing showing a state in which items are displayed on a screen of the item selection device of the present invention;

FIG. 5A is a drawing showing a state in which an item is selected from the front side of the screen;

FIG. 5B is a drawing showing a state in which an item is selected from the front side of the screen;

FIG. 6A is a drawing showing a state in which the inclination of the item selection device is measured;

FIG. 6B is a drawing showing a state in which the inclination of the item selection device is measured;

FIG. 7A is a drawing showing a state in which the inclination of the item selection device is changed;

FIG. 7B is a drawing showing a state in which the inclination of the item selection device is changed;

FIG. 8A is a drawing showing a state in which a condition of items displayed on the screen changes;

FIG. 8B is a drawing showing a state in which a condition of items displayed on the screen changes;

FIG. 9A is a drawing showing a state in which an item is selected from the back side of the screen;

FIG. 9B is a drawing showing a state in which an item is selected from the back side of the screen;

FIG. 10 is a flowchart showing a process flow according to the item selection of the present invention;

FIG. 11A is a drawing showing a state in which the three-dimensional shape of an item changes from a state showing a protrusion to a state showing an indentation, when the item is selected from the front side of the screen;

FIG. 11B is a drawing showing a state in which the three-dimensional shape of an item changes from a state showing a protrusion to a state showing an indentation, when the item is selected from the front side of the screen;

FIG. 12A is a drawing showing a state in which the three-dimensional shape of an item changes from a state showing an indentation to a state showing a protrusion, when the item is selected from the back side of the screen;

FIG. 12B is a drawing showing a state in which the three-dimensional shape of an item changes from a state showing an indentation to a state showing a protrusion, when the item is selected from the back side of the screen;

FIG. 13A is a drawing showing a state in which items are displayed with a display state degree determined based on the position on the screen; and

FIG. 13B is a drawing showing a state in which items are displayed with a display state degree determined based on the position on the screen.

### DETAILED DESCRIPTION

Embodiments of the present invention are described below. In the following, in order to make the invention easier to understand, embodiments for achieving the present invention by using an information processing device of the portable game device type are explained; however, the embodiments explained below are for explanation purposes and do not limit the scope of the present invention. Therefore, it is possible for one skilled in the art to employ embodiments in which equivalents of some or all of the elements of the embodiments described below are applied, and those embodiments as well are included within the range of the present invention.

Besides portable game equipment, electronic devices such as portable telephones, portable cameras and electronic dictionaries, as well as other portable information processing devices provided with touch panel-type input devices can be cited as information processing devices with which the item selection device according to the present invention can be realized.

### First Embodiment

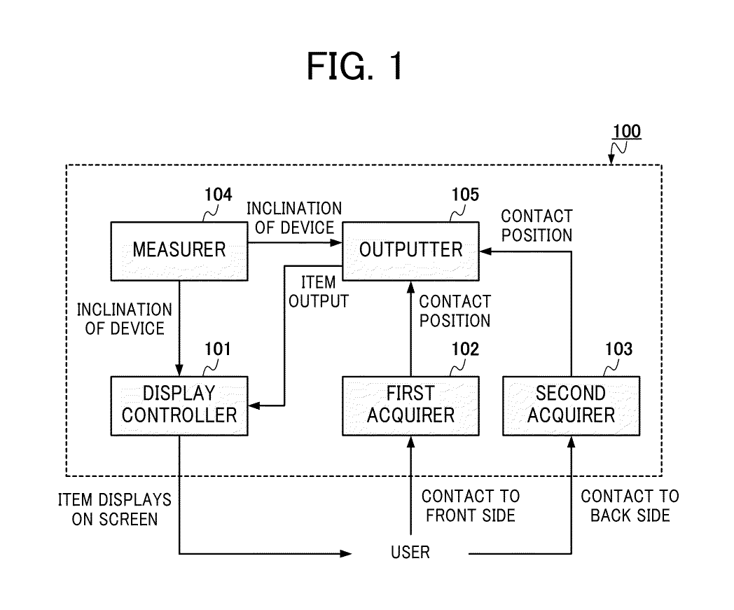

FIG. 1 shows an overview of the composition of the item selection device of the present invention.

An item selection device 100 is an item selection device 100 with which an item is selected by a user, and is provided with a display controller 101, a first acquirer 102, a second acquirer 103, a measurer 104 and an outputter 105.

The display controller 101 displays items on a screen. That is to say, the display controller 101 displays image data for items showing so-called buttons (selection buttons) for receiving operation input from the user on the screen of the item selection device 100, and provides this to the user.

The first acquirer 102 acquires the position of contact from the user on the front side of the screen. The second acquirer 103 acquires the position of contact from the user on the back side of the screen. That is to say, the first acquirer 102 and the second acquirer 103 acquire contact positions of touch operation by the user's finger and/or the like detected on the front side or back side of the screen, respectively. Furthermore, the first acquirer 102 and the second acquirer 103 provide the acquired contact positions to the outputter 105.

The measurer 104 measures the inclination of the item selection device 100. That is to say, the measurer 104 measures to what extent the item selection device 100 as a whole is in a state inclined with respect to the direction of gravity. Furthermore, the measurer 104 provides the measured inclination information to the display controller 101 and the outputter 105.

The outputter 105 outputs items selected on the basis of contact positions acquired by the first acquirer 102 and the second acquirer 103, respectively, based on the measured inclination. That is to say, the outputter 105 determines to use the contact position from which acquirer, out of the first acquirer 102 and the second acquirer 103, based on the inclination measured by the measurer 104, and outputs the selected item based on the contact position determined to be used. As a result, a prescribed process of the item selection device 100 is executed based on the output item, and this is reflected in the display controller 101 and/or the like.

In this manner, the item selection device 100 according to this embodiment receives the user's contact operation from the surface of the screen when the item selection device 100 is in an upward-facing state, and receives the user's contact operation from the back of the screen when the item selection device 100 is in a downward-facing state. As a result, operability is improved.

In this embodiment, the first acquirer 102 and the second acquirer 103 respectively acquire contact positions from the user detected by detection devices (sensors) capable of detecting contact. The item selection device 100 itself may be provided with this kind of detection device. Or, the item selection device 100 may acquire detection of a contact and detected contact positions by a detection device installed externally via a computer communication network.

Below, embodiments are explained in which a terminal device a user uses is provided with two touch panels as detection devices. However, the various parts in the embodiments cited hereafter may be appropriately distributed to terminal devices and server devices. For example, it is also possible to realize the item selection device of the present invention by communicating with external devices provided with two touch panels.

### Second Embodiment

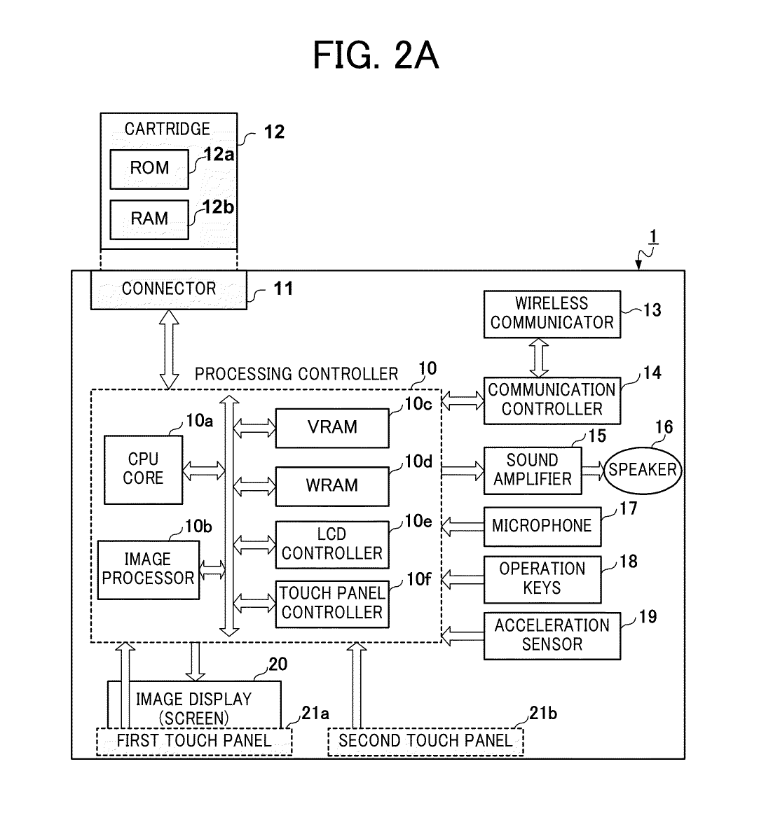

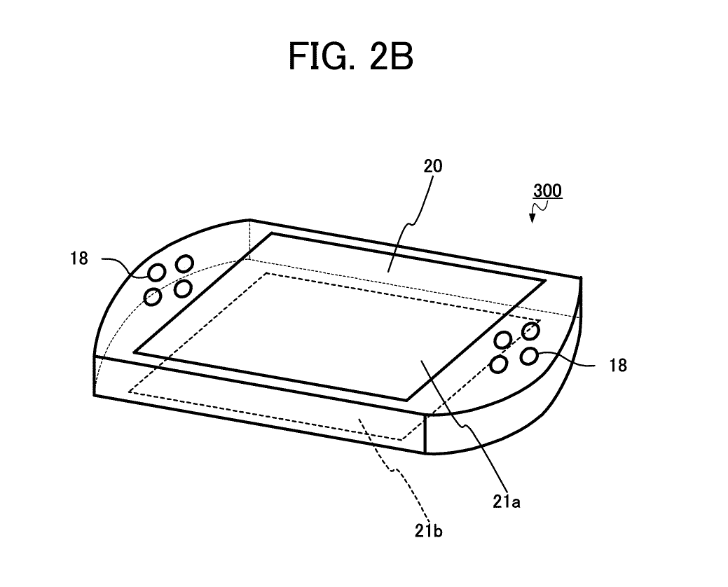

FIG. 2A is a schematic drawing showing the summary composition of a typical information processing device with which the item selection device according to the embodiments of the present invention can be realized. The explanation below makes references to FIG. 2A.

The information processing device 1 is provided with a processing controller 10, a connector 11, a cartridge 12, a wireless communicator 13, a communication controller 14, a sound amplifier 15, a speaker 16, a microphone 17, operation keys 18, an acceleration sensor 19, an image display 20, a first touch panel 21a and a second touch panel 21b.

In addition, the processing controller 10 is provided with a CPU (Central Processing Unit) core 10a, an image processor 10b, VRAM (Video Random Access Memory) 10c, WRAM (Work RAM) 10d, an LCD (Liquid Crystal Display) controller 10e and a touch panel controller 10f.

The CPU core 10a controls the actions of the information processing device 1 as a whole, is connected to the various constituent elements and exchanges control signals and data with such. Specifically, when the cartridge 12 is mounted in the connector 11, programs and data recorded in ROM (Read Only Memory) 12a inside the cartridge 12 is read and prescribed processes are executed.

The image processor 10b processes data read from the ROM 12a inside the cartridge 12 and data processed in the CPU core 10a, and then stores such in the VRAM 10c.

The VRAM 10c is frame memory for storing information used in displays, and stores image information processed by the image processor 10b and/or the like.

The WRAM 10d stores work data and/or the like necessary when the CPU core 10a is executing various types of processes in accordance with programs.

The LCD controller 10e controls the image display 20 and causes prescribed display images to be displayed. For example, the LCD controller 10e converts the image information stored in the VRAM 10c into a display signal with a prescribed synchronization timing, and outputs this to the image display 20. In addition, the LCD controller 10e displays prescribed instruction icons and/or the like on the image display 20.

The touch panel controller 10f detects contacts (touches) on the first touch panel 21a and the second touch panel 21b by a touch pen or a user's finger. For example, when prescribed instruction icons and/or the like are displayed on the image display 20, this controller detects contacts and releases (separation) on the first touch panel 21a and the second touch panel 21b, and detects the position of such.

The connector 11 is a terminal that can be freely attached to and detached from the cartridge 12, and when the cartridge 12 is connected, sends and receives prescribed data from the cartridge 12.

The cartridge 12 is provided with a ROM (Read Only Memory) 12a and a RAM (Random Access Memory) 12b.

Programs for realizing games and video data and audio data incident to games, and/or the like, are recorded in the ROM 12a.

Various data showing the progress status of the game and/or the like is stored in the RAM 12b.

The wireless communicator 13 is a unit for accomplishing wireless communication with wireless communicators of other information processing devices, and sends and receives prescribed data via an unrepresented antenna (built-in antenna and/or the like). The wireless communicator 13 can also accomplish wireless LAN communication with prescribed access points. In addition, a unique MAC (Media Access Control) address is indexed in the wireless communicator 13.

The communication controller 14 controls the wireless communicator 13 and serves as a go-between for communications accomplished between the processing controller 10 and processing controllers of other information processing devices, in accordance with prescribed protocols. In addition, when the information processing device 1 is connected to the Internet via a nearby wireless access point and/or the like, this controller serves as a go-between for wireless communication accomplished between the processing controller 10 and a wireless access point and/or the like in accordance with protocols conforming to wireless LAN (Local Area Network).

The sound amplifier 15 amplifies audio signals generated in the processing controller 12 and supplies such to the speaker 16. In addition, the speaker 16 is composed of stereos speakers and/or the like and outputs prescribed effects sounds and music sounds and/or the like in accordance with audio signals amplified by the sound amplifier 15.

The microphone 17 receives analog signals such as the user's voice and/or the like, and the signals undergo mixing and/or the like processes by the processing controller 10.

The operation keys 18 are composed of key switches and/or the like appropriately placed on the information processing device 1, and receive prescribed instruction input in accordance with operation by the user. A pressure sensor is provided in each of the operation keys 18, which can detect whether or not each key is pressed. The user inputs various types of operating instructions to the information processing device 1 by pressing these operation keys 18.

The acceleration sensor 19 is built into the information processing device 1, and can measure movement of the information processing device 1 in the three axial directions. That is to say, this sensor measures the movements that cause the information processing device held by the user to move, rotate and/or incline from the horizontal. This measurement result is supplied to the processing controller 10 and is used in processes such as the image processor 10b generating image data in accordance with the measurement results. In place of this kind of acceleration sensor, movement of the information processing device 1 may be measured by an angular acceleration sensor, an inclination sensor and/or the like.

The image display 20 is composed of an LCD and/or the like and appropriately displays image data through control by the LCD controller 10e. In addition, the image display 20 displays selection buttons (icons) and/or the like necessary for the user to input selection instructions by contacting the first touch panel 21a and the second touch panel 21b.

The first touch panel 21a is placed on top of the image display 20 and receives input by touch pen or the user's finger. In addition, the second touch panel 21b is positioned on a surface different from the image display 20, and similarly receives input by touch pen or the user's finger. The first touch panel 21a and the second touch panel 21b are composed for example of pressure-sensitive touch sensor panels, and detect touch operations such as contact and/or the like and the position thereof (touch position) and/or the like, by detecting the pressing force of the touch pen and/or the like. Or, the first touch panel 21a and the second touch panel 2 lb may detect contact by the user's finger and/or the like from changes in static electricity capacity.

FIG. 2B shows the external view of an item selection device realized using the information processing device 1. An item selection device 300 is provided on the front surface with a screen 20 (image display 20) for displaying image information, and furthermore operation keys 18 are positioned on both side surfaces thereof. Here, the first touch panel 21a is positioned overlapping the surface of the image display 20. On the other hand, the second touch panel 21b is positioned on the back surface of the item selection device 300, that is to say, on the side opposite the screen 20.

The user can input desired instructions by touching the surface of the first touch panel 21a or the surface of the second touch panel 21b with a fingertip. For example, the user can touch the first touch panel 21a with a thumb while holding both ends of the item selection device 300 with the hands. In addition, the user can touch the second touch panel 21b with a middle finger while holding both ends of the item selection device 300 with the hands.

In addition, in general the term touch panel often indicates a combination of a display device and an input device, but below the explanation is given indicating an input device that receives input through contact from a user as a device independent of the display device (image display 20). That is to say, the first touch panel 21a and the second touch panel 21b are both explained as input devices for receiving contact operations by the user. The first touch panel 21a is overlaid on the image display 20, and consequently the combination of this first touch panel 21a and the image display 20 can in general be called a touch screen. The second touch panel 21b is not overlaid on the image display 20 but is positioned independently, and can in general be called a touch pad.

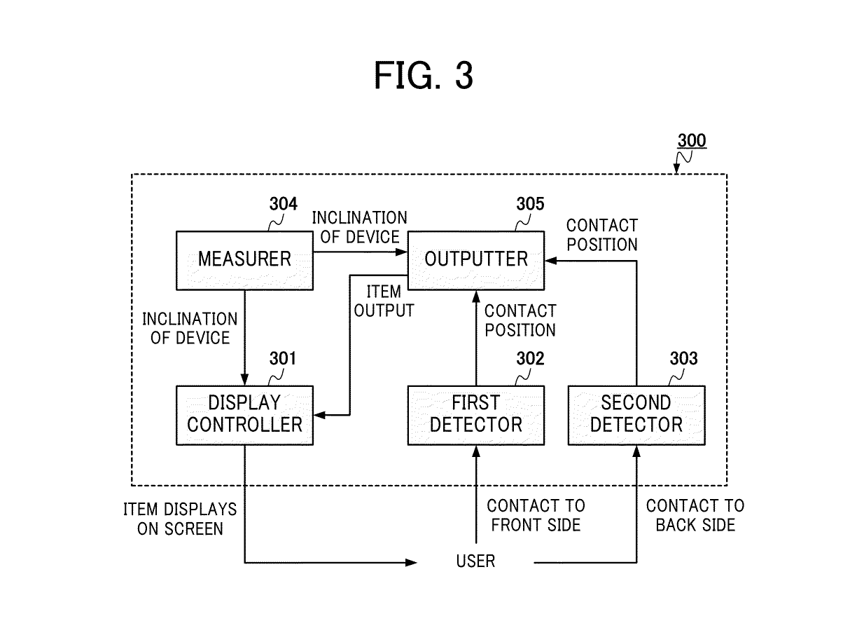

FIG. 3 shows the functional composition of the item selection device 300 realized using the information processing device 1.

The item selection device 300 is an item selection device 300 for causing the user to select an item, and is provided with a display controller 301, a first detector 302, a second detector 303, a measurer 304 and an outputter 305.

The item selection device 300 may also be appropriately provided with a memory unit and/or the like. Here, the memory unit is realized through the functions of various types of RAM and/or the like, for example, and stores the current time, content input by the user, the time of input and/or the like.

The display controller 301 displays items on the screen 20. That is to say, the display controller 301 functions as a display controller 101 in the first embodiment 1. “Item” means that which expresses a so-called button (selection button) for receiving operation input by the user. The display controller 301 displays image data showing this kind of item and various image data accompanying execution of other processes on the screen 20 (image display 20) and supplies such to the user. At this time, the display controller 301 receives inclination information from the item selection device 300 measured by the below-described measurer 304, and displays items in a condition based on this measured inclination. This kind of display controller 301 is realized by using the functions of the image processor 10b, the VRAM 10c and/or the like based on control by the CPU core 10a and the LCD controller 10e.

The first detector 302 detects contact by the user on the front side of the screen and acquires the position of the detected contact. The second detector 303 detects contact by the user on the back side of the screen and makes this the position of the detected contact. That is to say, the first detector 302 functions as the first acquirer 102 in the first embodiment, and the second detector 303 functions as the second acquirer 103 in the first embodiment. The first detector 302 and the second detector 303 detect touch operations by the user's finger and/or the like on the front side or back side of the screen, respectively, and acquire the contact positions thereof. Furthermore, the first detector 302 and the second detector 303 supply the acquired contact positions to the outputter 305. This kind of first detector 302 and second detector 303 are realized by respectively using the functions of the first touch panel 21a overlaid on the screen 20 (image display 20) and the second touch panel 21b positioned on the back surface of the screen 20 (image display 20), under the control of the CPU core 10a and the touch panel controller 10f.

The measurer 304 measures the inclination of this item selection device 300. That is to say, the measurer 304 functions as the measurer 104 in the first embodiment. The “inclination of the item selection device 300” indicates in what direction the item selection device 300 as a whole is directed with respect to the direction of gravity. That is to say, the measurer 304 detects the direction of gravity through the acceleration sensor 19 built into the item selection device 300, and measures in what state of inclination with respect to the direction of gravity the item selection device 300 as a whole is in. Furthermore, the measurer 304 provides the measured inclination information to the display controller 301 and the outputter 305. This kind of measurer 304 is realized by using the functions of the acceleration sensor 19 and/or the like, under control of the CPU core 10a.

The outputter 305 outputs the item selected based on the position of contact detected by the first detector 302 and the second detector 303, based on the measured inclination. That is to say, the outputter 305 functions as the outputter 105 in the first embodiment. That is to say, the outputter 305 receives the inclination measured by the measurer 304 and the contact positions detected by the first detector 302 and the second detector 303. The outputter 305 analyzes the contact position from which detector to use, based on the received inclination, and outputs the selected item based on the contact position judged to be used. As a result, the prescribed processes of the item selection device 300 are executed based on the output item and are reflected on the display controller 301 and/or the like. This kind of outputter 305 can be realized by the CPU core 10a working together with various components such as the VRAM 10c and the WRAM 10d and/or the like.

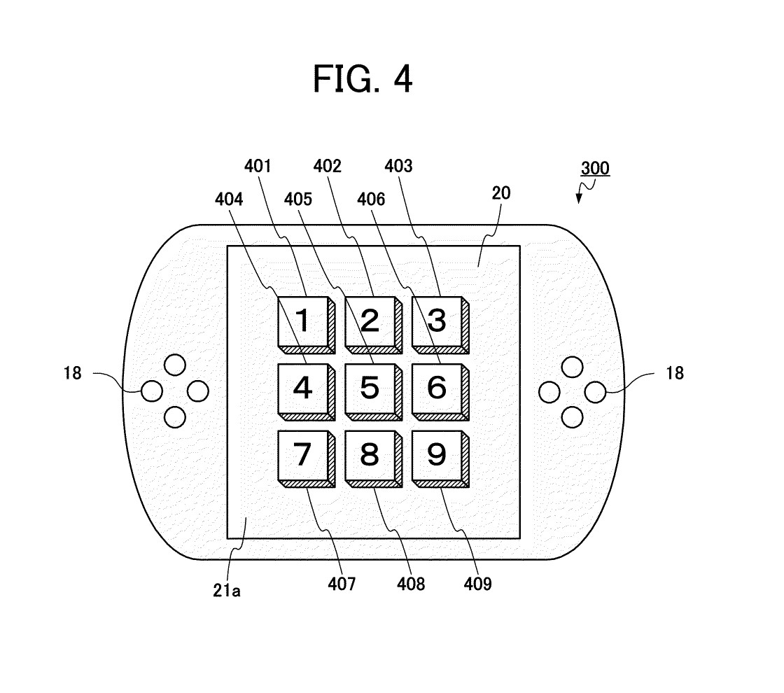

FIG. 4 shows the state in which items are displayed on the screen 20 of the item selection device 300. This FIG. 4 shows the state when the screen 20 of the item selection device 300 is viewed from the front, and as an example, shows the state in which nine items 401 to 409 to which the numerals from “1” to “9” are affixed are displayed on the screen 20. The display controller 301 displays these items 401 to 409 on the screen 20 of the item selection device 300.

These items 401 to 409 show the so-called buttons (selection buttons) for receiving operation input by the user. In order to make it easy to understand from outward appearance that these are selection buttons, the display controller 301 displays the items 401 to 409 respectively on the screen 20 in a prescribed state showing that the three-dimensional shape is a protrusion, that is to say mimicking a three-dimensional shape as through sticking out toward the user viewing the screen 20. The user can select any of the nine items 401 to 409 displayed on the screen 20, and can accomplish an input operation by touching an item image with a finger and/or the like.

The items 401 to 409 shown in FIG. 4 are one example, and the item selection device 300 may display various items on the screen 20 as items the user can select. For example, this is not limited to the numbers from “1” to “9” being affixed, for visible representations may include various text, symbols, pictures, colors and/or the like. The items are not limited to a square shape, but may be circular, polygonal, or various other shapes. The items may be displayed in any size at any position in the screen 20.

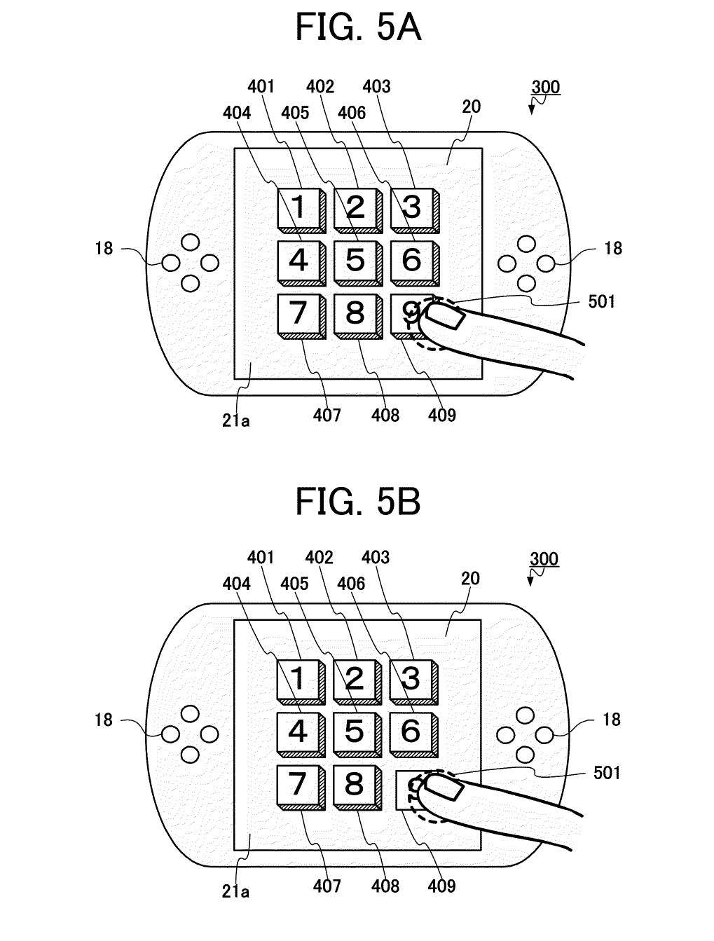

FIGS. 5A and 5B show the state of an item being selected from the front side of the screen 20 by the user. Here, as in FIG. 4, the nine items 401 to 409 with the numerals “1” to “9” affixed are displayed on the screen 20. The state of an item being selected by the user touching and contacting the screen 20 will be explained with reference to FIGS. 5A and 5B.

First, as shown in FIG. 5A, the user, trying to select the item 409 to which the number “9” is affixed, contacts the position of the item 409 on the screen 20 with a finger. That is to say, this is the case in which the user contacts with a finger the item 409 shown in a protrusion shape, just like pressing a button from the top.

At this time, contact on this item 409 is detected by the first detector 302. That is to say, the first touch panel 21a is positioned overlaying the screen 20 of the item selection device 300, and by using the functions of this first touch panel 21a, the first detector 302 detects contact by the user to the screen 20. Furthermore, the first detector 302 acquires a contact position 501 on that first touch panel 21a.

Whereupon, as shown in FIG. 5B, the item 409 displayed on the screen 20 corresponding to the contact position 501 is selected. That is to say, when the first detector 302 detects the contact, the outputter 305 outputs the item 409 displayed in that contact position 501 and executes a process corresponding to that item 409.

At this time, the display controller 301 displays the selected item 409 changing from a state indicating that the three-dimensional shape is a protrusion to a flat state that is not a protrusion. That is to say, the button seemingly sticking out toward the user is pressed and changes to a shape as though pressed. Through this, it is easy for the user to confirm that this item 409 has been selected.

The outputter 305 need not execute the output process of the item 409 immediately after the first detector 302 detects the contact, but may wait for the first detector 302 to detect release of the contact before executing the output process. That is to say, it is fine for the output process to be executed only when the user contacts the item image to be selected with a finger and/or the like and then releases that contact. Through this, it is possible to prevent erroneous operation and/or the like compared to the case when the output process is executed immediately after a contact, because prior to output the user can confirm which item was selected.

In addition, in particular when the first touch panel 21a is composed of pressure-sensitive touch panel sensors, the first detector 302 may further detect and acquire the strength of pressing when the user contacts the screen 20 with a finger. Furthermore, when the acquired strength of the pressing exceeds a prescribed threshold value, the item displayed at the contact position may be considered selected. That is to say, it is fine to have it so that even when the user contacts an item displayed on the screen 20, until the pressing strength exceeds a prescribed threshold value, that item is not selected, and when the pressing is of a strength exceeding the prescribed threshold value, only then is that item selected.

Furthermore, the state of the item displayed by the display controller 301 at the contact position may be gradually changed in accordance with the strength of the pressing acquired by the first detector 302. That is to say, the degree showing the protrusion of an item displayed in a state showing that the three-dimensional shape is a protrusion may gradually become smaller as the strength of the acquired pressing increases, so that the display state of the item ultimately changes to a flat state. Through this, the action just like a button sticking out toward the user being gradually pressed by the pressure by the user's finger can be more faithfully mimicked, improving operability and/or the like.

In this way, when contact is detected, the item displayed at the contact position 501 changes from a state showing that the three-dimensional shape is a protrusion to a flat state that is not a protrusion, and that item is output. Through this, the user can intuitively accomplish input operations with a sensation just like pressing a button.

The contact position 501 is normally not a point on the screen 20 but has an area of contact corresponding to the size of a finger, so there are cases when this extends over positions in which multiple items are displayed. In such a case, typically one item whose area of contact is largest is selected from among the multiple items. That is to say, the display controller 301 and the outputter 305 accomplish the above-described processes with the item having the largest area over which the contact position 501 supplied from the first detector 302 extends as the one selected.

In the item selection device 300 of this embodiment, the measurer 304 measures the inclination of the item selection device 300. As described below, this is because the touch panel used for the display process and output of the items 401 to 409 changes between front and back based on the inclination.

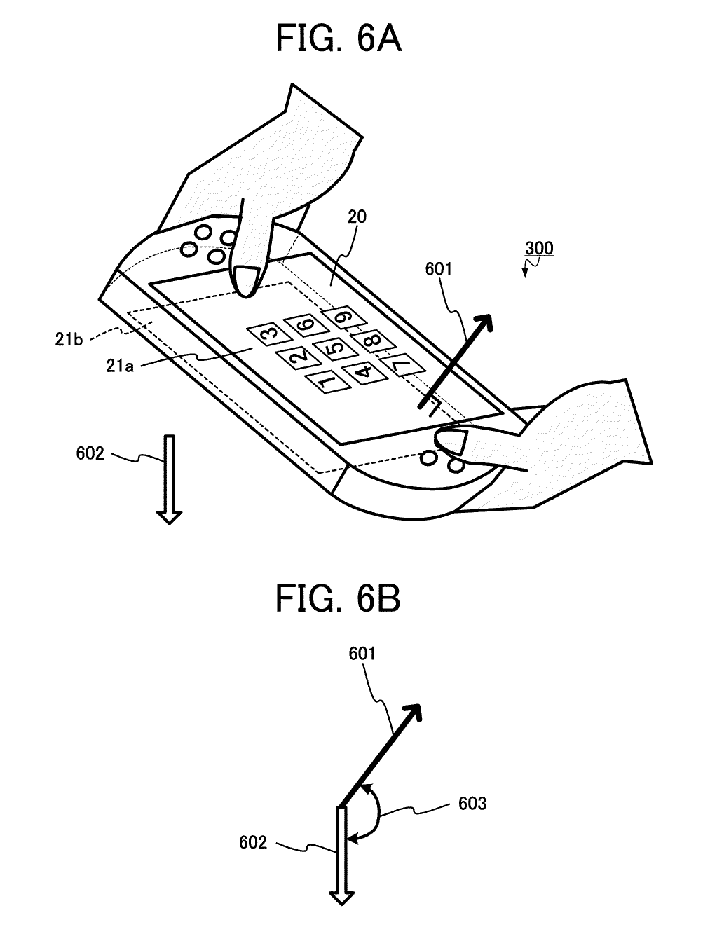

Specifically, FIGS. 6A and 6B show the state in which the inclination of the item selection device 300 is measured. First, FIG. 6A shows the typical state in which the item selection device 300 is operated by the user, that is to say the user grasps the item selection device 300 with both hands and operates the device with the screen 20 facing upward.

At this time, the measurer 304 measures the inclination of the item selection device 300, that is to say in what direction the item selection device 300 as a whole is facing with respect to the direction of gravity. Consequently, the measurer 304 acquires an outward facing normal vector 601 with respect to the screen 20 and a gravity vector 602. The “outward facing normal vector 601” is a vector orthogonal to that screen 20 with a point on the screen 20 as the starting point, and is a vector facing to the outside of the item selection device 300. The “gravity vector 602” is a vector in the direction of gravity, that is to say, in a vertical direction downward toward the earth's surface. The gravity vector 602 is acquired by using a function of the acceleration sensor 19 provided in the item selection device 300. That is to say, as shown in FIG. 6A, when the device is held so that the screen 20 is facing upward, the outward facing normal vector 601 for the screen 20 faces in a direction roughly opposite the gravity vector 602.

The measurer 304 measures an angle 603 between the acquired two vectors, that is to say the outward facing normal vector 601 for the screen 20 and the gravity vector 602, as shown in FIG. 6B. When the device is held such that the screen 20 is facing upward and the outward facing normal vector 601 and the gravity vector 602 face in roughly opposite directions, the angle 603 measured is an obtuse angle, that is to say an angle larger than 90 degrees, as shown in FIG. 6B.

The measurer 304 takes this measured angle 603 as an indicator of the inclination of the item selection device 300. Furthermore, the display controller 301 displays the items 401 to 409 with the state changed based on this inclination.

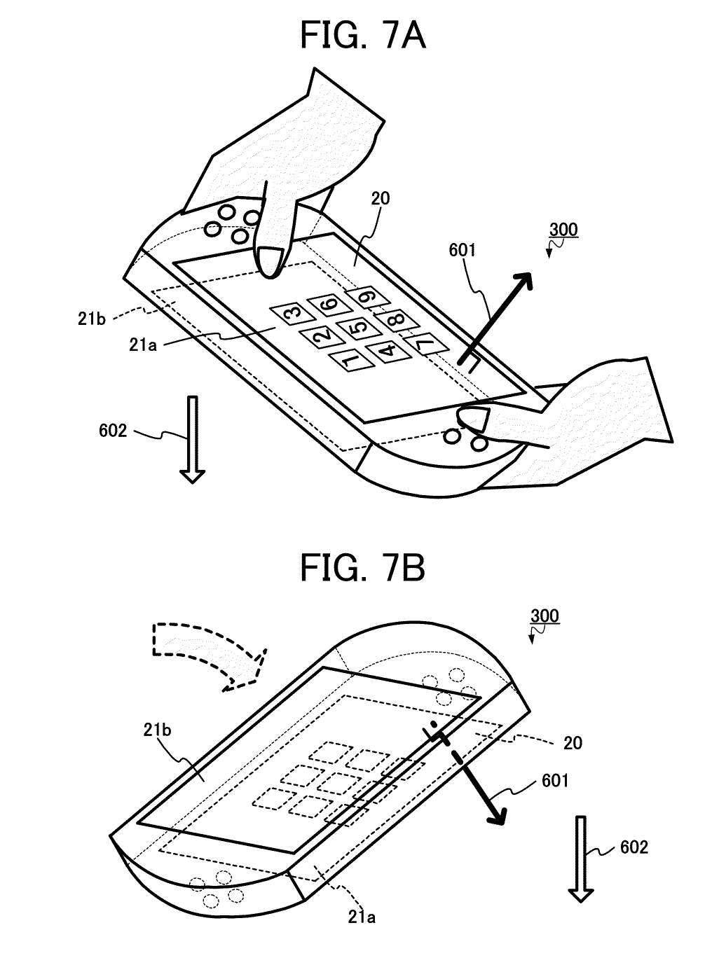

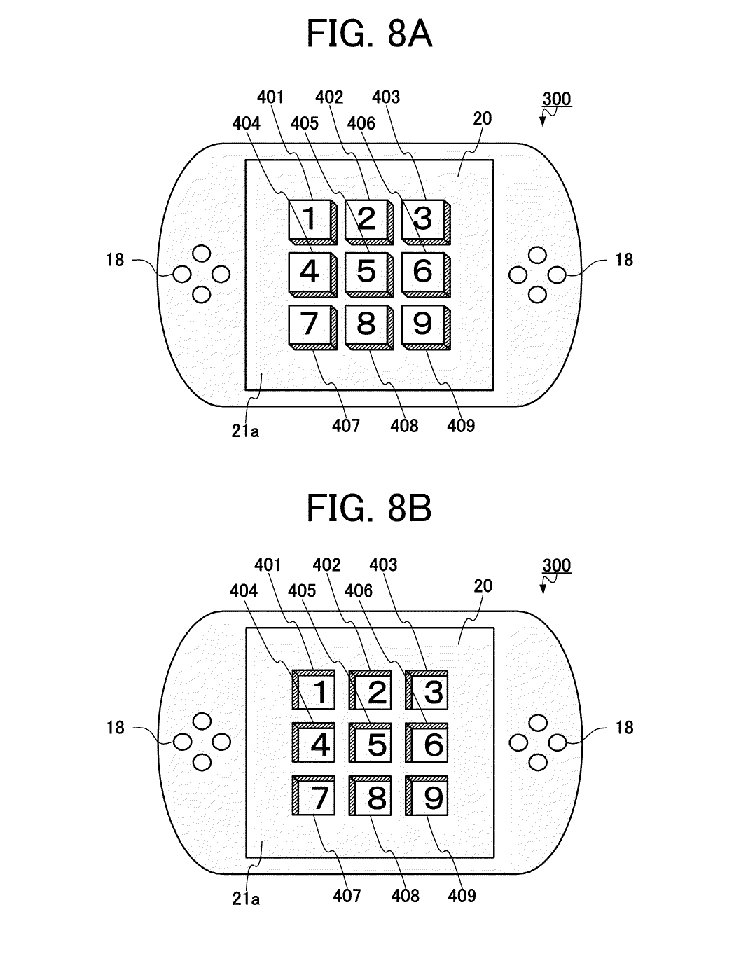

FIGS. 7A and 7B show the state when the inclination of the item selection device 300 is changed. Furthermore, FIGS. 8A and 8B show the state where the condition of the items 401 to 409 displayed on the screen 20 changes accompanying a change in the inclination of the item selection device 300. Similar to the explanation to this point, the explanation will take as an example a situation in which the nine items 401 to 409 to which the numerals from “1” to “9” are affixed are displayed on the screen 20.

FIG. 7A is the same figure as FIG. 6A, and shows the state in which the user grasps the item selection device 300 with both hands and operates the device with the screen 20 facing upward. Because the screen 20 is facing upward, the inclination of the item selection device 300 measured by the measurer 304, that is to say the angle 603 formed by the outward facing normal vector 601 of the screen 20 and the gravity vector 602, is an obtuse angle.

At this time, the items 401 to 409 displayed on the screen 20 are in a state showing the three-dimensional shape to be a protrusion, as shown in FIG. 8A. That is to say, when the measured angle 603 is an obtuse angle, the display controller 301 displays the items 401 to 409 in a state mimicking a three-dimensional shape as through sticking out toward the user viewing the screen 20. By displaying the buttons so as to stick out to the front side of the screen in this manner, the user viewing this screen 20 can easily confirm when pressing a button that the button should be pressed from the front side of the screen 20.

Now suppose that the user rotates the item selection device 300 from this state, so that the screen 20 is facing downward, as shown in FIG. 7B. That is to say, this is a state that as a result of the user changing posture for example so as to lie down and face upward, the item selection device 300 is operated in a posture such as looking up at the screen 20. By the screen 20 facing downward, the outward facing normal vector 601 also faces downward. Consequently, the inclination of the item selection device 300 measured by the measurer 304, that is to say the angle 603 formed by the outward facing normal vector 601 and the gravity vector 602, becomes an acute angle, that is to say an angle less than 90 degrees.

At this time, the items 401 to 409 displayed on the screen 20 are in a state showing that the three-dimensional shape is an indentation, as shown in FIG. 8B. That is to say, when the measured angle 603 becomes acute, the display controller 301 displays the items 401 to 409 in a state mimicking a three-dimensional shape so as to appear sunken by the user viewing the screen 20. By displaying the buttons as though sticking out toward the back side of the screen 20 in this manner, when pressing a button the user viewing this screen 20 can easily confirm that the button should be pressed from the back side of the screen 20.

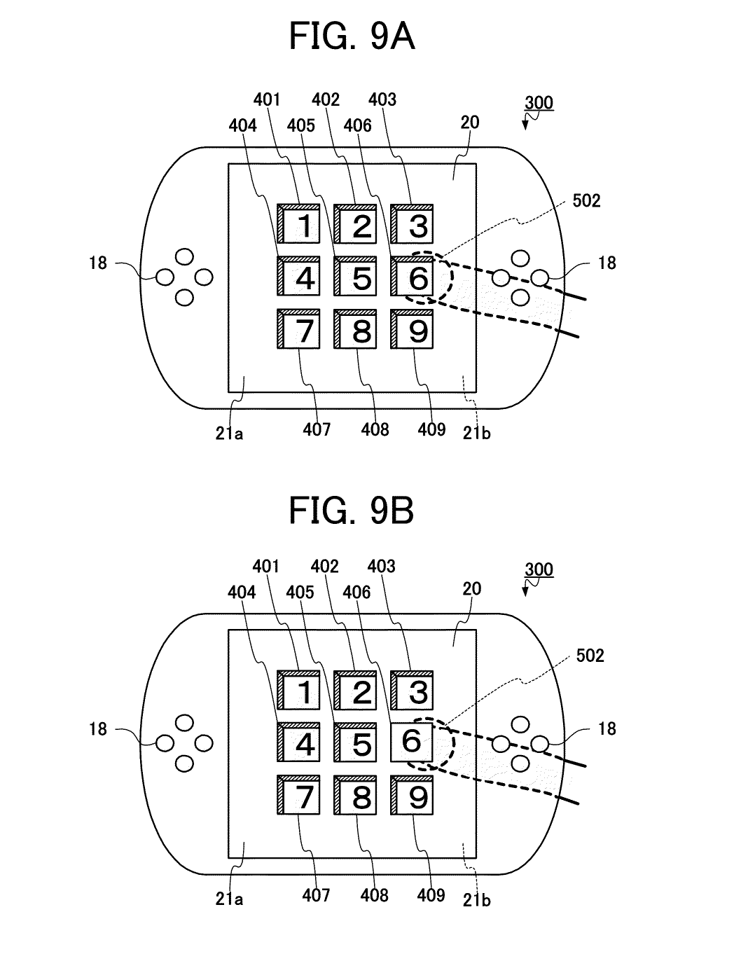

In reality, FIGS. 9A and 9B show the state when an item is selected by the user from the back side of the screen 20. In FIGS. 9A and 9B, the item selection device 300 is inclined so that the screen 20 faces downward as in FIG. 7B, and the nine items 401 to 409 are displayed on the screen 20 in a state showing that the three-dimensional shape is an indentation.

First, as shown in FIG. 9A, suppose that the user contacts the position of the item 406 on the screen 20 with a finger, trying to select item 406 to which the numeral “6” is affixed,. That is to say, this is the case when the item 406 displayed in an protruding shape toward the back side of the screen 20 is contacted by the user with a finger from the back of the screen 20 as though pressing a button from above.

At this time, touching of this item 406 is detected by the second detector 303. That is to say, using the functions of the second touch panel 21b on the back side of the screen 20 installed in addition to the first touch panel 21a that overlays the screen 20, the second detector 303 detects contact from the back side of the screen 20 and acquires a contact position 502 on this second touch panel 21b.

When this occurs, the item 406 displayed on the screen 20 corresponding to the contact position 502 is selected, as shown in FIG. 9B. That is to say, when the second detector 303 detects contact from the back side of the screen 20, the outputter 305 outputs the item 406 displayed in the position on the screen 20 corresponding to the contact position 502 on the back side of this screen 20, and executes a process corresponding to that item 406.

At this time, the display controller 301 displays the selected item 406 changing from a state showing that the three-dimensional shape is an indentation to a flat state with no indentation. That is to say, the display changes to a shape as though the button sticking out toward the back side with respect to the user viewing the screen 20 is pressed in from the back side. Through this, it is easy for the user to confirm that this item 406 was selected.

In order to more faithfully mimic the action of a button being pressed similar to the first detector 302, the second detector 303 may further detect and acquire the strength of the pressing when the user contacts the back side of the screen 20 with a finger, particularly when the second touch panel 21b is composed of pressure-sensitive touch panel sensors. Furthermore, when this acquired strength of pressing exceeds a prescribed threshold value, the item display at the position on the screen 20 corresponding to the contact position may be selected.

Furthermore, the display controller 301 may cause the state of the item displayed at the position on the screen 20 corresponding to the contact position to change gradually in accordance with the pressing strength acquired by the second detector 303. That is to say, the stronger the acquired pressing becomes, the less the degree to which the indentation of the item displayed in a state showing that the three-dimensional shape is an indentation may become, and the display state of the item may ultimately change to a flat state. Through this, an action like a button sticking out to the back side with respect to the user viewing the screen 20 being pressed gradually by the pressure by the user's finger can be faithfully mimicked, which helps improve operability.

In this manner, operation input by contact by the user is received by the second touch panel 21b installed on the back surface of the screen 20, in a state in which the item selection device 300 as a whole is inclined so that the screen 20 is facing downward. Furthermore, when contact from this back side is detected, the item displayed on the screen 20 corresponding to the contact position 502 changes from a state showing that the three-dimensional shape is an indentation to a flat state with no indentation, and that item is output. Through this, the user can do input operations from the back side of the screen 20 when holding the item selection device 300 so as to look up at the screen 20. Consequently, the user can do input operations using a different finger without using the fingers supporting the item selection device 300 as a whole.

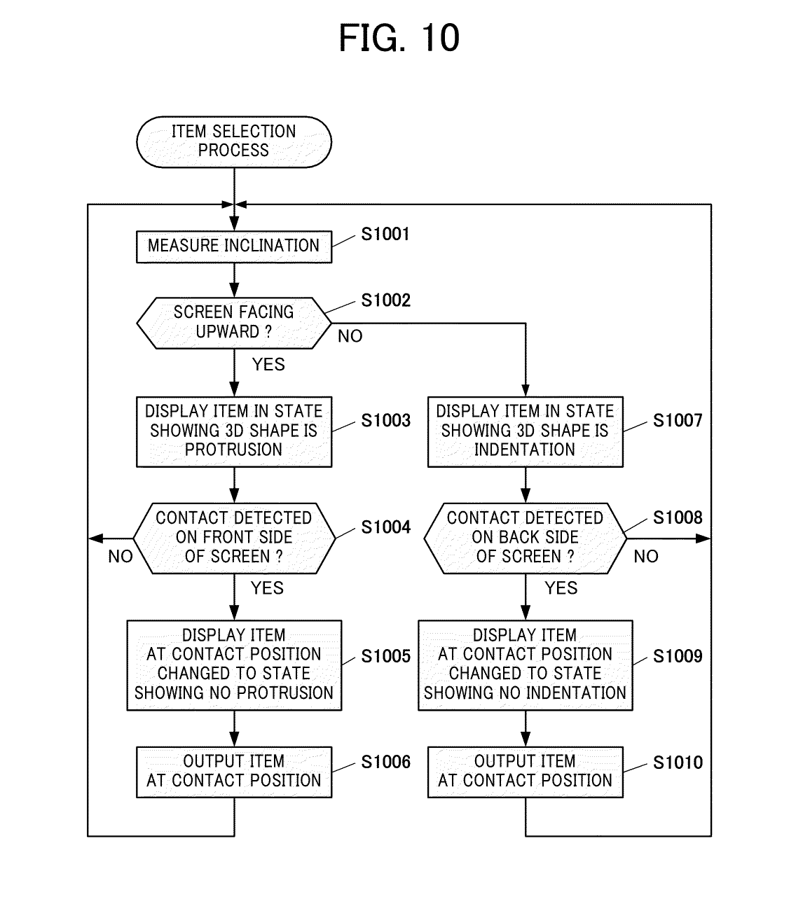

FIG. 10 is a flowchart showing the process flow according to the item selection of this embodiment. A summarized flow of processes realized in this embodiment explained to this point is explained below.

When this process is started, the processing controller 10 of the item selection device 300 performs various initialization processes and then the measurer 304 measures the inclination of the item selection device 300 (step S1001). That is to say, the measurer 304 measures in what direction the screen 20 of the item selection device 300 is facing with respect to the gravity direction. Specifically, as shown in FIGS. 6A and 6B, the measurer 304 acquires the outward facing normal vector 601 of the screen 20 and the gravity vector 602 and measures the angle 603 formed by these.

Furthermore, a determination is made as to whether or not the screen 20 is facing upward (step S1002). That is to say, a determination is made as to whether the angle 603 measured by the measurer 304 in step S1001 is an obtuse angle (an angle larger than 90 degrees and smaller than 180 degrees) or an acute angle (an angle larger than 0 degrees and smaller than 90 degrees). Through this, the item selection device 300 determines whether the screen 20 is in an upward-facing state or a downward-facing state with respect to the gravity direction. Specifically, when the angle 603 is an obtuse angle, the screen is upward-facing, and conversely, when the angle 603 is acute, the screen 20 is downward-facing.

When the measured angle is equal to 0 degrees or 180 degrees, the angle is technically neither acute nor obtuse, but for example these may be covered by including 0 degrees with the acute angles and 180 degrees with the obtuse angles, for example. In addition, when the measured angle is 90 degrees, that is to say when the item selection device 300 is inclined so that the screen 20 is facing a perpendicular direction with respect to the gravity direction, the angle may be included with either the acute angles or obtuse angles. Or, it would be fine to determine whether this is an acute angle or an obtuse angle in accordance with the state to that point, so that when the measured angles have been obtuse angles to that point, when the angle becomes 90 degrees this is included with the obtuse angles, and when the state has been acute angles to that point becomes 90 degrees, this is included with the acute angles.

When the screen 20 is facing upward, that is to say when the measured angle 603 is obtuse (step S1002: Yes), the display controller 301 displays on the screen 20 the state showing the items that the user can select with a three-dimensional shape that is a protrusion (step S1003). That is to say, the display controller 301 creates an image of items that the user can select by pressing from the front side of the screen 20, and outputs this to the screen 20 with a prescribed synchronization timing. Specifically, as shown in FIG. 8A, the display controller 301 displays a state mimicking a three-dimensional shape as though sticking out toward the user viewing the screen 20 so that it is easy to recognize that the items 401 to 409 are selection buttons to be pressed from the front side of the screen 20.

When the items are displayed, next a determination is made as to whether or not the first detector 302 has detected contact on the front side of the screen 20 (step S1004). That is to say, by the first detector 302 detecting contact by the user's finger and/or the like through the first touch panel 21a overlaid on the screen 20, it can be determined whether or not the user has tried to select an item from the front side of the screen 20.

When contact is not detected (step S1004: No), the process returns to step S1001. That is to say, when the first detector 302 does not detect contact from the front side of the screen 20, the inclination of the item selection device 300 is again measured by the measurer 304 (step 51001) and a determination is made as to whether or not the screen 20 is facing upward based on that measurement (step S1002). Furthermore, the processes from step S1003 to step S1006, or the processes from step S1007 to step S1010, are executed based on that measurement.

On the other hand, when contact is detected (step S1004: Yes), the display controller 301 changes the display to a state showing that the item at the contact position is not a protrusion (step S1005). That is to say, the display controller 301 creates an item image in a flat state different from the state displayed to that point, for the item displayed at the position of contact detected by the first detector 302, and outputs such to the screen 20 with a prescribed synchronization timing. Specifically, as shown in FIG. 5B, the display state of the item 409 in the contact position 501 is changed from a state appearing to stick out toward the user viewing the screen 20 to a flat state as though a button had been pressed.

Then, the outputter 305 outputs the item at the contact position (step S1006). That is to say, the item displayed at the position of contact detected by the first detector 302 is selected and the outputter 305 executes the process corresponding to that item.

At this time, the output process may be executed after waiting for release of the contact to be detected by the first detector 302, primarily to prevent erroneous operation, although such is not noted in the flowchart. In addition, after the output process is done, the display controller 301 may return the state of the item displayed changed in above-described step S1005 to the original state, that is to say to a state showing that the three-dimensional shape is a protrusion so that it is easy to recognize that the output process has concluded.

When the touch panel sensor is pressure sensitive, it would be fine for the first detector 302 to also acquire the strength of the contact and in above-described step S1005 for the display controller 301 to gradually change the state showing that the item at the contact position is not a protrusion as that acquired contact strength becomes larger, so as to more faithfully mimic the action of pressing a button. Furthermore, in step S1006 it would be fine for the outputter 305 to output the item at the contact position when that detected contact strength exceeds a prescribed threshold value.

Following this, the process returns to step S1001. That is to say, when the output process has concluded, the measurer 304 again measures the inclination of the item selection device 300 (step S1001). Furthermore, a determination is made as to whether or not the item selection device 300 is in a state such that the screen 20 thereof is facing upward, based on that measurement (step S1002).

Below, the case where the screen 20 is facing downward, that is to say when the measured angle 603 is acute (step S1002: No), is explained. That is to say, this is the case when the user is operating the item selection device 300 in a posture such that the screen 20 is facing downward for example when lying down and looking up, as shown in FIG. 7B.

In this case, the display controller 301 displays the items 401 to 409 on the screen 20 in a state showing that the three-dimensional shape is an indentation (step S1007). That is to say, in contrast to the case where the screen 20 is upward-facing, the display controller 301 generates an image of items that can be selected by the user pressing from the back side of the screen 20 and outputs such to the screen 20 with a prescribed synchronization timing. Specifically, as shown in FIG. 8B, the display controller 301 displays the items 401 to 409 in a state mimicking a three-dimensional shape that appears to be sunken from the user viewing the screen so it is easy to confirm that this is a selection button to be pressed from the back side of the screen 20.

When the items are displayed, next a determination is made as to whether or not the second detector 303 has detected contact on the back side of the screen 20 (step S1008). That is to say, through the second touch panel 21b installed on the back side of the screen 20, the second detector 303 determines whether or not the user has tried to select an item from the back side of the screen 20 by detecting contact by the user's finger and/or the like.

When contact is not detected (step S1008: No), the process returns to step S1001. That is to say, when the second detector 303 does not detect contact from the back side of the screen 20, the inclination of the item selection device 300 is again measured by the measurer 304 (step S1001) and a determination is made as to whether or not the screen 20 is facing upward based on that measurement (step S1002). Furthermore, the processes from steps S1003 to step S1006, or the processes from step S1007 to step S1010, are executed based on that measurement.

On the other hand, when contact is detected (step S1008: Yes), the display controller 301 changes the display to a state showing that the item at the contact position is not an indentation (step S1009). That is to say, the display controller 301 creates an item image in a flat state different from the state displayed to that point, for the item displayed at the position of contact detected by the second detector 303, and outputs such to the screen 20 with a prescribed synchronization timing. Specifically, as shown in FIG. 9B, the display state of the item 406 in the contact position 502 is changed from a state appearing to be sunken from the user viewing the screen 20 to a flat state as though a button were pressed from the back side of the screen 20.

Then, the outputter 305 outputs for the item at the contact position (step S1010). That is to say, the item displayed at the position of contact detected by the second detector 303 is selected and the outputter 305 executes the process corresponding to that item.

At this time, the output process may be executed after waiting for release of the contact to be detected by the second detector 303, primarily to prevent erroneous operation, although such is not noted in the flowchart. In addition, after the output process is done, the display controller 301 may return the state of the item displayed changed in above-described step S1009 to the original state, that is to say to a state showing that the three-dimensional shape is an indentation, so that it is easy to recognize that the output process has concluded.

In addition, similar to above-described steps S1005 and S1006, when the touch panel sensor is pressure sensitive, it would be fine for the second detector 303 to also acquire the strength of the contact and in above-described step S1009 for the display controller 301 to gradually change the state showing that the item at the contact position is not an indentation as that acquired contact strength becomes greater, so as to more faithfully mimic the action of pressing a button. Furthermore, in step S1010 it would be fine for the outputter 305 to output the item displayed at the position on the screen 20 corresponding to the contact position when that detected contact strength exceeds a prescribed threshold value.

Following this, the process returns to step S1001. That is to say, when the output process has concluded, a determination is made as to whether an input operation from either the front side or back side of the screen has been received based on the inclination of the item selection device 300 measured by the measurer 304. Furthermore, execution of the above-described display and output processes is repeated based on that determination.

In this manner, the item selection device 300 according to this embodiment receives operation input from the back side of the screen 20 when operated with the screen in an upward-facing state and receives operation input from the back side of the screen 20 when operated with the screen 20 in a downward-facing state, through the touch panels provided respectively on the front and back of the screen 20. As a result, the user can do input operations using a finger different from the fingers supporting the item selection device 300 as a whole regardless of the posture with which the item selection device 300 is held. Consequently, the user's operability is improved and additional fatigue caused by operation is reduced and damage caused by dropping the device can be prevented.

### Third Embodiment

Next, the third embodiment of the present invention will be explained. In the second embodiment, the display controller 301 changed the display of the item selected by the user from a state showing that the three-dimensional shape is a protrusion or a state showing this to be an indentation to a flat state. In contrast, with this embodiment, the display controller 301 changes the display of the item selected by the user from a state showing that the three-dimensional shape is a protrusion to a state in which this is an indentation, or from a state showing that the three-dimensional shape is an indentation to a state in which this is a protrusion.

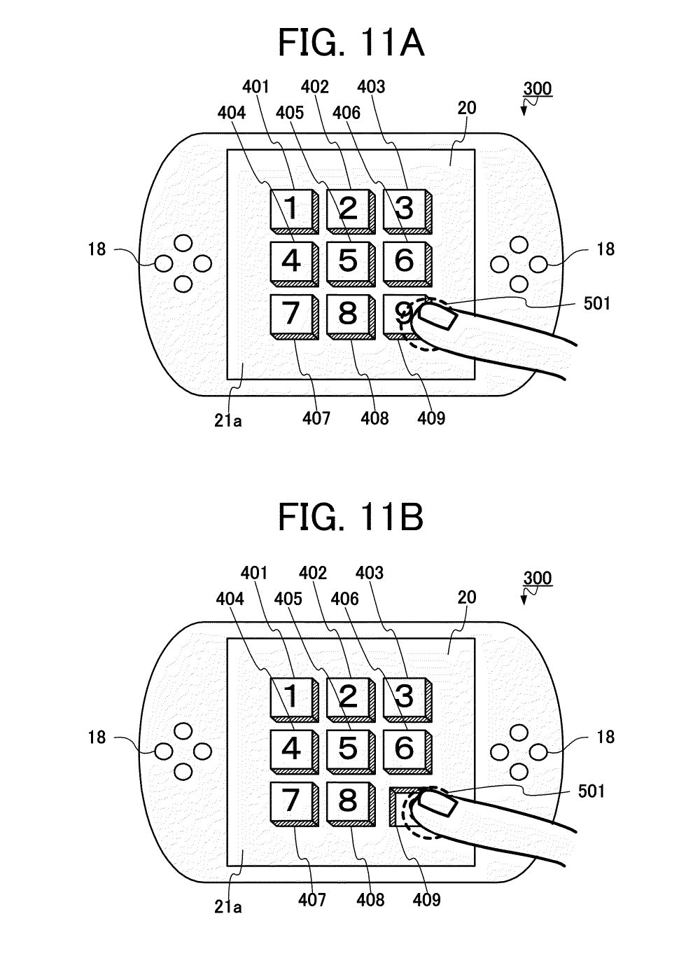

FIGS. 11A and 11B show the state in which the state showing that the three-dimensional shape of the item is a protrusion changes to a state showing this is an indentation, when an item is selected from the front side of the screen 20. Similar to FIG. 5A, in FIG. 11A the nine items 401 to 409 to which the numerals from “1” to “9” are affixed are displayed on the screen 20 in a state showing that the three-dimensional shape is a protrusion. Furthermore, suppose the user contacts the position of the item 409 on the screen 20 with a finger in order to select the item 409 to which the numeral “9” is affixed. At this time, contact to that item 409 is detected by the first detector 302 through the functions of the first touch panel 21a overlaid on the screen 20. As a result, the item 409 displayed in the contact position 501 is selected.

Whereupon, as shown in FIG. 11B, the display controller 301 changes the display of the selected item 409 from a state showing that the three-dimensional shape is a protrusion to a state showing this to be an indentation. That is to say, unlike the first embodiment (FIG. 5B), the selected item 409 does not change to a flat state but changes from a state protruding toward the user viewing the screen 20 to a sunken state just as though being pressed from the front side of the screen 20.

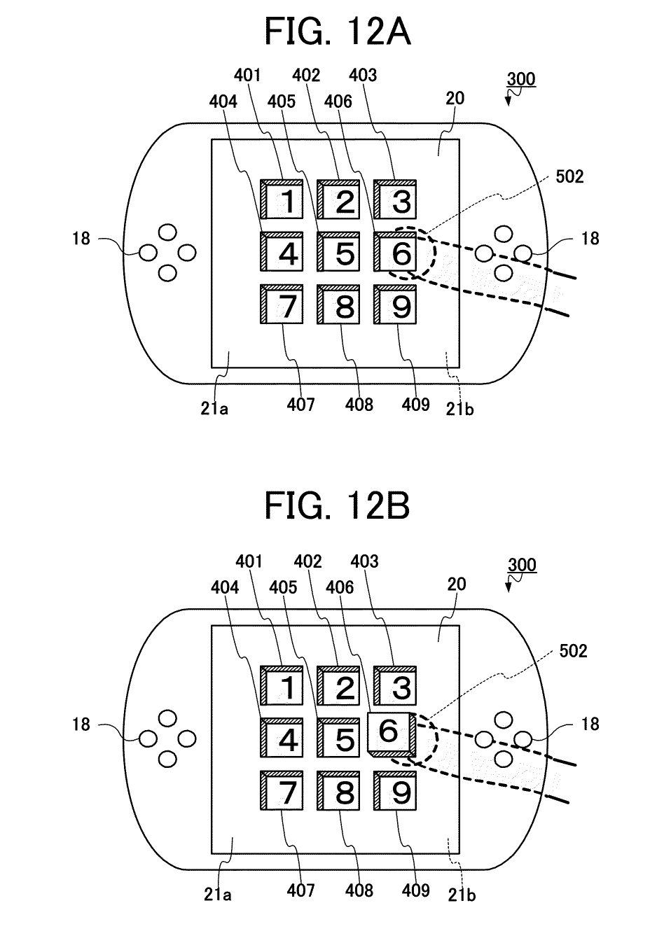

On the other hand, FIGS. 12A and 12B show the state in which the three-dimensional shape of an item changes from a state showing a protrusion to a state showing an indentation, when the item is selected from the back side of the screen 20. Similar to FIG. 9A, in FIG. 12A the nine items 401 to 409 to which the numerals from “1” to “9” are affixed are displayed on the screen 20 in a state showing that the three-dimensional shape is an indentation. Furthermore, suppose the user contacts the position of the item 406 on the screen 20 with a finger from the back side of the screen 20 in order to select the item 406 to which the numeral “6” is affixed. At this time, contact to that item 406 is detected by the second detector 303 through the functions of the second touch panel 21b positioned on the back side of the screen 20. As a result, the item 406 displayed in the contact position 502 is selected.

Whereupon, as shown in FIG. 12B, the display controller 301 changes the display of the selected item 406 from a state showing that the three-dimensional shape is an indentation to a state showing this to be a protrusion. That is to say, unlike the first embodiment (FIG. 9B), the selected item 406 does not change to a flat state but changes from a state sunken from the user viewing the screen 20 to a state sticking out just as though being pressed from the back side of the screen 20.

In this manner, the item selection device 300 according to this embodiment can show the state of the item 401 to 409 selected just as though a button is pressed from the surface on which the user does a contact operation as the state displaying the items 401 to 409, by preparing at least two states, namely the “state showing that the three-dimensional shape of the item is a protrusion” and the “state showing that the three-dimensional shape of the item is an indentation.” Consequently, the item selection device 300 according to this embodiment can realize making the state in which an item 401 to 409 is selected easier for the user to recognize efficiently while controlling to the extent possible the volume of data used.

### Fourth Embodiment

Next, the fourth embodiment of the present invention is explained. In the second and third embodiments, the items 401 to 409 were displayed on the screen 20 in a state showing that the three-dimensional shape is a protrusion or a state showing that this is an indentation, but there was no change in the display state of these items based on the position on the screen 20. For example, as shown in FIG. 4, the positions on the screen 20 where the nine items 401 to 409 are displayed differ, but there is no difference among the nine items 401 to 409 with regard to the state showing that the three-dimensional shape is a protrusion.

In contrast, in this embodiment the degree of the display state of the items displayed on the screen, that is to say the degree (protrusion degree) showing the protrusion of the state showing that the three-dimensional shape of the item is a protrusion (protrusion degree) and the degree showing the indentation of the state showing that the three-dimensional shape of the item is an indentation (indentation degree) are determined based on the position of that item displayed on the screen 20.

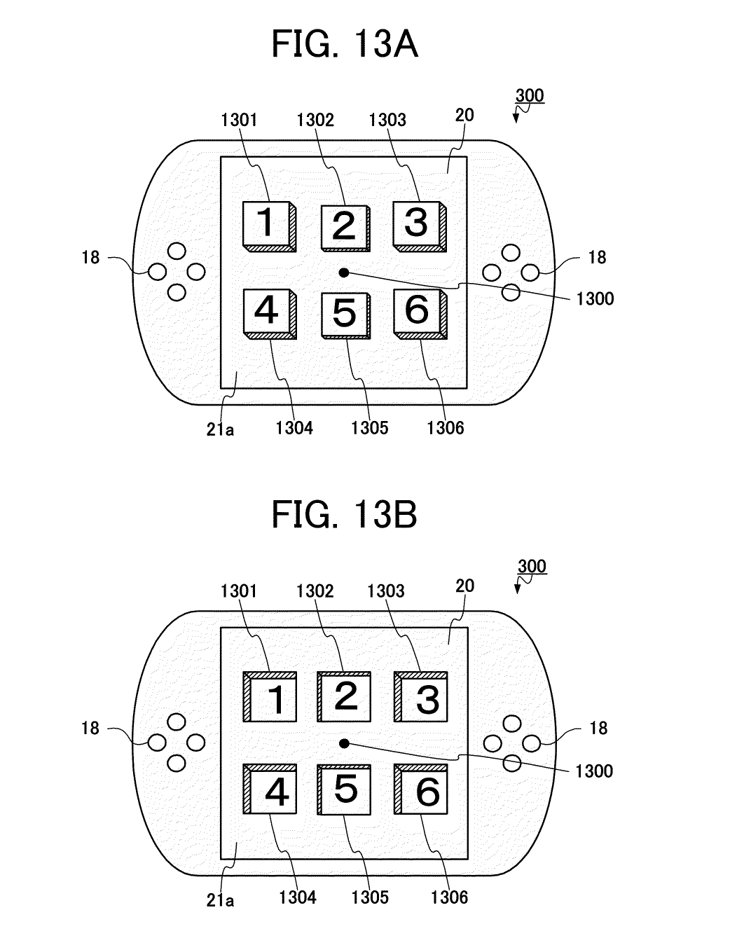

FIGS. 13A and 13B show the state in which items are displayed with the display state degree determined based on the position on the screen 20. In FIG. 13A, six items 1301 to 1306 to which the numerals from “1” to “6” are affixed are displayed on the screen 20 of the item selection device 300 in a state showing that the three-dimensional shape is a protrusion. That is to say, FIG. 13A, like FIG. 7A in the second embodiment, shows the condition on the screen in the state in which the item selection device 300 is held so that the screen 20 thereof is facing upward with respect to the gravity direction. Furthermore, the six items 1301 to 1306 are displayed in a three-dimensional shape mimicking buttons to be pressed from the top side of the device, that is to say the front side of the screen 20.

In FIG. 13A, the protrusion degree of the displayed items, that is to say the size of the extent to which the three-dimensional shape with which the items 1301 to 1306 are displayed sticks out is not uniform for all six of the items 1301 to 1306. That is to say, strengths are given to the protrusion degrees of the items 1301 to 1306 based on the positions at which such are displayed on the screen 20. As a result, the display state of the items 1301 to 1306 is divided into shapes of buttons sticking out more in the direction of the user viewing the screen 20 and shapes of buttons not sticking out as much.

To explain concretely, with this embodiment a center position on the screen 20 is established in advance as a predetermined standard position 1300. Furthermore, the display controller 301 displays items displayed at positions a greater distance from this standard position 1300 with a larger protrusion degree. In FIG. 13A, the item 1302 to which “2” is affixed and the item 1305 to which “5” is affixed are displayed at positions close to the center of the screen 20 compared to the other four items 1301, 1303, 1304 and 1306, that is to say at positions a shorter distance from the standard position 1300. Consequently, the item 1302 to which “2” is affixed and the item 1305 to which “5” is affixed are displayed with a smaller protrusion degree than the other four items 1301, 1303, 1304 and 1305.

In contrast, in FIG. 13B the six items 1301 to 1306 to which the numerals from “1” to “6” are affixed are displayed on the screen 20 of the item selection device 300 in a state showing that the three-dimensional shape is an indentation. That is to say, FIG. 13B shows the condition on the screen 20 in a state in which the item selection device 300 is held upside down so that the screen 20 thereof is facing downward with respect to the gravity direction, as in FIG. 7B of the second embodiment. Furthermore, the six items 1301 to 1306 are displayed in three-dimensional shapes mimicking buttons to be pressed from the back side of the screen 20.

Similar to the fact that the protrusion degrees of the items 1301 to 1306 were not uniform in FIG. 13A, in FIG. 13B the indentation degrees of the displayed items, that is to say the degree of the sunkenness of the three-dimensional shapes with which the items 1301 to 1306 are displayed is not uniform among the six items 1301 to 1306. That is to say, magnitudes are applied to the indentation degrees of the items 1301 to 1306 based on the positions where such as displayed on the screen 20. As a result, to the user viewing the screen the display states of the items 1301 to 1306 can be divided into shapes of buttons that are more sunken and shapes of buttons that are not sunken very much.

Furthermore, items displayed at positions larger distances from the standard position 1300 set in advance in the position at the center of the screen 20 are displayed with larger indentation degrees. Specifically, the item 1302 to which “2” is affixed and the item 1305 to which “5” is affixed are displayed at positions close to the center of the screen 20 compared to the other four items 1301, 1303, 1304 and 1306, that is to say at positions a shorter distance from the standard position 1300. Consequently, the item 1302 to which “2” is affixed and the item 1305 to which “5” is affixed are displayed with a smaller indentation degree than the other four items 1301, 1303, 1304 and 1305.

In this manner, by displaying the items 1301 to 1306 with magnitudes applied to the protrusion degrees or indentation degrees (display state degrees) thereof, the user viewing the screen 20 can readily recognize that the items 1302 and 1305 displayed at positions near the center of the screen 20 may be pressed with relatively weak force compared to items 1301, 1303, 1304 and 1306 displayed at positions separated from the center.

When the user is holding and operating the item selection device 300 with both hands near both edges of the screen 20, the items 1301, 1303, 1304 and 1306 displayed at positions closer to the two edges of the screen 20 are easier for the user's fingers to reach and are thought to be relatively easy to contact and operate. In contrast, the items 1302 and 1305 displayed at positions closer to the center of the screen 20 are more difficult for the user's fingers to reach and are thought to be more difficult to contact and operate. That is to say, because the user must contact and operate the device with the same hand with which the device is being held, contact and operation of items displayed at positions separated from the positions of the fingers supporting the device becomes more difficult.

When the user forcibly attempts to select the items 1302 and 1305 near the center, it is easy for the force pressing against the force supporting the device as a whole to become strong, making it easy for accidents to occur, such as the device being dropped. Consequently, the item selection device 300 according to this embodiment prompts the user to not press the items 1302 and 1305 displayed at positions close to the center of the screen 20 with an unnecessarily strong force, thereby improving operability and yielding effects such as preventing damage and dropping of the device caused by operation of the device in an unreasonable posture.

The prescribed standard position 1300 was explained as being set at a position in the center of the screen 20 in FIGS. 13A and 13B, but this is not limited to the center of the screen and may be established in advance at another position. That is to say, the position where a user has difficulty with contact operations with a finger and/or the like may change in accordance with the shape of the item selection device 300 and the position of the screen placed therein. Consequently, even in positions near the edge of the screen 20 and not just in the center of the screen 20, a prescribed standard position 1300 may be established if this is a position where the display state degree of the item should be made relatively small and the user should be prompted to not press that item with unnecessarily strong force.

Or, the prescribed standard position 1300 may be not limited to a single point on the screen 20 but may target a line on the center axis of the screen 20, for example. That is to say, the display state degree of an item may be displayed greater as the distance from the line on the central axis of the screen 20 increases, for example.

In addition, the protrusion degree and the indentation degree (display state degrees) may change depending on the position within a single item and not just have the display state degrees change for each item based on distance from the standard position 1300. That is to say, the display controller 301 may display an item in a three-dimensional shape with a gradient applied to the display state degree within one item so that the display state degree of a position near the standard point 1300 becomes relatively small and the display state degree of a position separated from the standard position 1300 becomes relatively large. Through this, it is possible to further enhance the effect of causing the user to be aware to not press with unnecessarily strong force at positions in the screen 20 near the standard point 1300.

Furthermore, not only is the strength displayed in the display state degree of items on the screen 20, but in reality the threshold value for strength of contact with which an item is selected when an item is contact operated, that is to say a threshold value that does not determine that an item was selected if the item was not pressed with strength greater than that threshold value, may also be changed across the items 1301 to 1306. That is to say, it is possible for a user to see from outward appearance whether an item is one that may be pressed with strong force or is an item that should be pressed with weak force just by applying strengths to the display state degrees of the items 1301 to 1306. On the other hand, by changing the threshold value for the strength of contact that determines whether an item was actually selected for each item in conjunction with display state degree, it is possible to further enhance the effect of improving operability.

In this case, the first detector 302 and the second detector 303 further detect and acquire the strength of contact in addition to the absence or presence of a contact by the user and the position thereof. That is to say, the first touch panel 21a overlaid on the screen 20 and the second touch panel 21b positioned on the back side of the screen are composed of pressure-sensitive touch panels that can detect pressure when the panel is contacted, and detect the strength of contact by the user.

In addition, it is possible to set the threshold value of the pressure for determining that an item was selected so as to be proportional to the size of the display state degree of an item, in order to select that item with a strength appropriately reflecting the display state degree of that item. That is to say, items displayed with a relatively small protrusion degree, such as the item 1302 to which “2” is affixed and the item 1305 to which “5” is affixed in FIG. 13A, have a relatively small threshold value set. Consequently, it is possible for the user to select those items without pressing with a strong force. On the other hand, items displayed with a relatively large protrusion degree, such as the other four items 1301, 1303, 1304 and 1306 in the same FIG. 13A, have relatively high threshold values set. Consequently, it is necessary for the user to press with relatively strong force in order to select those items.

Moreover, at this time the display controller 301 may cause the state of the item at the contact position to change gradually in accordance with the strength of the pressing force acquired by the first detector 302 or the second detector 303. That is to say, the protrusion degree and/or the indentation degree of the item displayed at the position corresponding to the contact position may change so as to become gradually smaller the greater the strength of the detected pressing force becomes. Through this, it is possible to more faithfully mimic the action of a button gradually being pressed by pressure by the user's finger, which can help improve operability.

In this manner, the item selection device 300 according to this embodiment causes the protrusion degree or indentation degree of the item to change based on the position where such is displayed on the screen 20, and furthermore cases the threshold value of the strength of the pressing force that determines whether an item was selected to change based on that protrusion degree or indentation degree. As a result, it is possible to control to the extent possible behavior such as pressing with an unnecessarily strong force an item displayed at a position difficult to contact operate and difficult for the user's finger to reach. Consequently, this has the effect of improving operability and preventing damage and falls to the device caused by operation of the device in an unreasonable posture.

As described above, with the present invention it is possible to provide an item selection device, an item selection method and a non-transitory information recording medium suitable for making a selection of an item displayed on a screen easy in accordance with the inclination of the device.

Having described and illustrated the principles of this application by reference to one or more preferred embodiments, it should be apparent that the preferred embodiments may be modified in arrangement and detail without departing from the principles disclosed herein and that it is intended that the application be construed as including all such modifications and variations insofar as they come within the spirit and scope of the subject matter disclosed herein.

What is claimed is:

1. An item selection device for allowing a user to select an item, comprising:
a display controller that displays the item on a screen;
a first acquirer that acquires a position of contact by the user on a front side of the screen;
a second acquirer that acquires a position of contact by the user on a back side of the screen;
a measurer that measures an inclination of the item selection device; and
an outputter that (a1) outputs an item selected based on the position of contact acquired by the first acquirer when the measured inclination satisfies a prescribed first condition, and (a2) outputs an item selected based on the position of contact acquired by the second acquirer when the measured inclination satisfies a prescribed second condition;
wherein the display controller (b1) displays the item in a prescribed first state when the measured inclination satisfies the prescribed first condition and (b2) displays the item in a prescribed second state when the measured inclination satisfies the prescribed second condition.

2. The item selection device according to claim 1, wherein:
the prescribed first condition is satisfied when an angle formed by an outward facing normal vector to the screen and a gravity vector is an obtuse angle; and
the prescribed second condition is satisfied when an angle formed by an outward facing normal vector to the screen and a gravity vector is an acute angle.

3. The item selection device according to claim 1, wherein:
the prescribed first state is a state showing that a three-dimensional shape of the item is a protrusion;
the prescribed second state is a state showing that a three-dimensional shape of the item is an indentation; and
the display controller (c1) displays the item changed from the prescribed first state to a state showing that the three-dimensional shape of the item is not a protrusion when the measured inclination satisfies the prescribed first condition, and moreover a position of contact by the user is acquired by the first acquirer and the item is selected based on the position of contact, and (c2) displays the item changed from the prescribed second state to a state showing that the three-dimensional shape of the item is not an indentation when the measured inclination satisfies the prescribed second condition, and moreover a position of contact by the user is acquired by the second acquirer and the item is selected based on the position of contact.

4. The item selection device according to claim 3, wherein:
the state showing that the three-dimensional shape of the item is not a protrusion is the prescribed second state; and
the state showing that the three-dimensional shape of the item is not an indentation is the prescribed first state.

5. The item selection device according to claim 3, wherein at least one out of a degree indicating the protrusion of the state indicating that the three-dimensional shape of the item is a protrusion, and a degree indicating the indentation of the state indicating that the three-dimensional shape of the item is an indentation (hereafter called “display state degrees”) is determined based on a position of the item displayed on the screen.

6. The item selection device according to claim 5, wherein as a distance of the position of the item displayed on the screen from a prescribed standard position on the screen increases, the display state degree of the item increases.

7. The item selection device according to claim 5, wherein:
the first acquirer further acquires a strength of contact by the user on the front side of the screen;
the second acquirer further acquires a strength of contact by the user on the back side of the screen;
(d1) an item is selected if the strength of contact acquired by the first acquirer is greater than a threshold value determined in accordance with the display state degree of the item displayed at a position based on the position of the contact; and
(d2) an item is selected if the strength of contact acquired by the second acquirer is greater than a threshold value determined in accordance with the display state degree of the item displayed at a position based on the position of the contact.

8. An item selection method executed by an item selection device for allowing a user to select an item and comprising a display controller, a first acquirer, a second acquirer, a measurer and an outputter, wherein the item selection method comprises:
a display step in which the display controller displays the item on a screen;
a first acquisition step in which the first acquirer acquires a position of contact by the user on a front side of the screen;
a second acquisition step in which the second acquirer acquires a position of contact by the user on a back side of the screen;
a measurement step in which the measurer measures an inclination of the item selection device; and
an output step in which the outputter (a1) outputs an item selected based on the position of contact acquired by the first acquirer when the measured inclination satisfies a prescribed first condition, and (a2) outputs an item selected based on the position of contact acquired by the second acquirer when the measured inclination satisfies a prescribed second condition;
wherein in the display step, the display controller (b1) displays the item in a prescribed first state when the measured inclination satisfies the prescribed first condition and (b2) displays the item in a prescribed second state when the measured inclination satisfies the prescribed second condition.

9. A non-transitory information recording medium on which is recorded a program for causing a computer to function as an item selection device that allows a user to select an item, wherein the program causes the computer to function as:
a display controller that displays the item on a screen;
a first acquirer that acquires a position of contact by the user on a front side of the screen;
a second acquirer that acquires a position of contact by the user on a back side of the screen;
a measurer that measures an inclination of the item selection device; and
an outputter that (a1) outputs an item selected based on the position of contact acquired by the first acquirer when the measured inclination satisfies a prescribed first condition, and (a2) outputs an item selected based on the position of contact acquired by the second acquirer when the measured inclination satisfies a prescribed second condition;
wherein the display controller (b1) displays the item in a prescribed first state when the measured inclination satisfies the prescribed first condition and (b2) displays the item in a prescribed second state when the measured inclination satisfies the prescribed second condition.
